(19) United States
(12) Patent Application Publication
(10) Pub. No.: US 2004/0022926 A1
(43) Pub. Date: Feb. 5, 2004

(54) Rice-based food product and method for making it

(76) Inventors: Ezio Bartocci, Piacenza (IT); Mario De Luigi, Fiorenzuola D'Arda (IT)

Correspondence Address: James V. Costigan, Esq., Hedman & Costigan, P.C., Suite 2003, 1185 Avenue of the Americas, New York, NY, 10036-2646, US

(21) Appl. No.: 10/462,099

(22) Filed: Jun. 12, 2003

(30) Foreign Application Priority Data
Jun. 12, 2002 (IT) MI 2002 A 001300

(51) Int. Cl. A23L 1/168

(52) U.S. Cl. 426/618

(57) ABSTRACT

A rice-based food product, specifically designed for human nourishing, characterized in that said food product is made starting from whole rice, a fractionating extraction of said whole rice and a following recovering of said whole rice components, by varying their related amounts in a selected manner to provide a final food product having different and optimum nourishing characteristics.

### BACKGROUND OF THE INVENTION

The present invention relates to a rice-based food product, which has been specifically designed for human feeding.

More specifically, the invention relates to a so-called rice-milk, which has been specifically designed for providing a whole nourishing food product, i.e. suitable to provide all the macronourishing substances such as carbohydrates, proteins and fats, necessary for a healthy and equilibrated human feeding.

In recent years, through the overall world, the need of having healthy, easily digestible food products, suitable for all persons is greatly increased.

For example, it is known that third-world people cannot tolerate lactose.

Such an intolerance, in particular milk and soybean protein intolerance, moreover, is increasing also in occidental countries.

Thus, it would be greatly advantageous to provide food products, of vegetable origin, rich in complex carbohydrates, unsaturated fats and proteins, greatly efficient from the nutritional standpoint.

In this connection it should be pointed out that the sole alternative, related to vegetable protein rich food products, has been up to now soybean which, however, is affected by the problem of a comparatively high digestive intolerance, also due to the fact that soybean is frequently a genetically modified one.

In particular, soybean milk and other cereal based drinks or beverages are to be considered as unbalanced from a nutritional standpoint; actually soybean milk does not comprise a sufficient amount of carbohydrates, whereas other available cereal based drinks, in particular based on rice and oats, have insufficient protein and fat contents.

Accordingly, and as stated, it would be very advantageous to provide a food product suitable for the world populations, in particular for persons who, for different reasons, such as biologic intolerance, religious and ideologic ties, sub-nourishing and the like cannot use similar food products.

To meet the above requirements, in particular, the target food product must meet the following requirements.

It should be made starting from rice, which is a well available cereal, of low cost, and well tolerated by all persons.

It, moreover, should be made by simple processes and easily available techniques.

It, furthermore, should be suitable for packaging in highly hygienic conditions, thereby preserving all of its organoleptic and nourishing propertied for a long period, without using dangerous preserving substances or low packaging and shipment temperatures, at a very low cost; moreover the food product should not be deteriorated in hot times and climates.

Moreover, the food product should have such a taste and aspect to meet all requirements of possible consumers, and should be satisfactorily tolerated and assimilated.

Rice milk based food products meeting the above requirements are already known, for example, from the U.S. Pat. Nos. 4,744,992 and 4,894,242, Italian Patent No. 1279533 and EP Patent No. 970614.

However, the food product disclosed in the above mentioned U.S. Patents, have great nutritional lacks, of the order of 3.5% of proteins and fats, bas on the dry fraction thereof, and comprise a vegetable origin base and an animal origin base.

Thus, they cannot be considered suitable for a broad range of world populations and, in particular, for persons allergic to milk or lactose proteins.

Lactose, in particular, even in minimum doses and accordingly tolerable by intolerant persons, could not be however used by allergic persons who cannot tolerate any traces of this component.

Thus, as stated, it would be advantageous to provide a whole rice milk based food product, alternative to animal and soybean milk, comprising rice as the sole component thereof.

In fact, as is well known, rice is the most tolerated digestible and diffused cereal; however it has a very low protein and fat contents much less than that of animal and soybean milk and, accordingly, must be supplemented with protein and fat substances.

Several food combinations, using vegetable proteins, such as soybean pea and carob proteins, with animal milks and related products, i.e. milk serum, have also been provided; however, they have a lot of drawbacks and limitations for a comparatively high portion of possible users, such as intolerance, difficult digestion and so on.

### SUMMARY OF THE INVENTION

Thus, the aim of the present invention is to provide such a food product specifically designed for overcoming the above mentioned drawbacks, including exclusively, as stated, rice, fractionated by a selective extraction and hydrolysis and then reconstituted, so as to change at will the components thereof.

Within the scope of the above aim, a main object of the invention is to provide a rice-based milk providing all the above mentioned advantages of conventional products, i.e. great contents of proteins and fats, without having their drawbacks.

Another object of the invention ia to provide a rice-based milk which is easily digestible and well tolerated by all consumers.

### BRIEF DESCRIPTION OF THE DRAWINGS

Further characteristics and advantages of the present invention will become more apparent hereinafter from the following detailed disclosure of a preferred, though not exclusive, embodiment thereof, which is illustrated, by way of an indicative, but not limitative, example, in the accompanying drawings, where:

FIG. 1 schematically shows several possible applications of rice; and

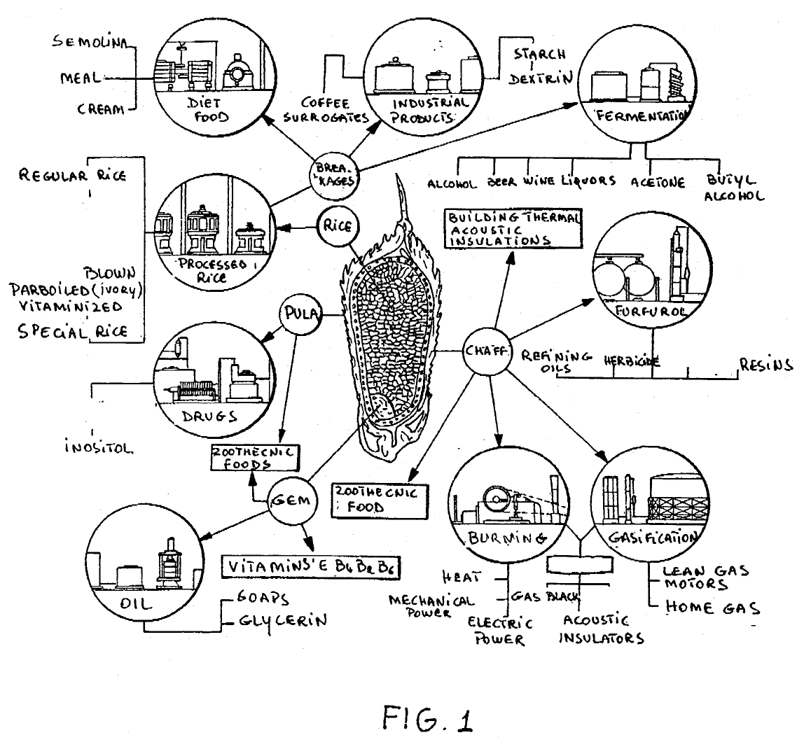

FIG. 2 is a flow diagram of a preferred method for making the rice-based food product according to the present invention.

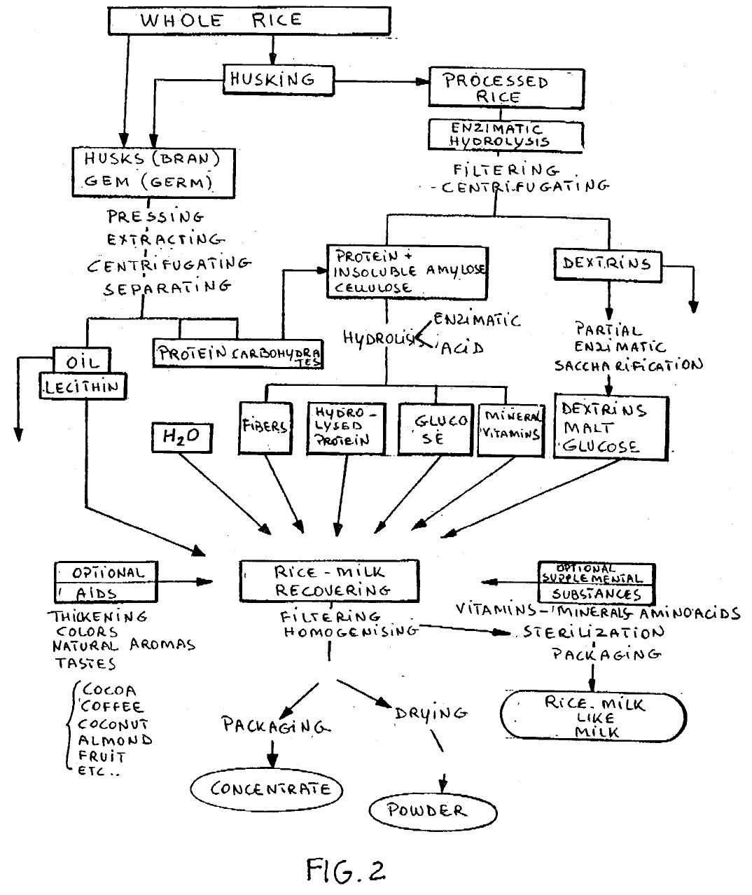

### DESCRIPTION OF THE PREFERRED EMBODIMENTS

The rice-based food product according to the present invention is made starting from whole rice, rice chaff (rice bran) and rice germ, by carrying out a specifically designed processing method, which also constitutes a main aspect of the present invention.

More specifically, starting from whole rice, preliminarily processed by enzymatically transforming it by alpha-amylasis and/or pollulanasis, is then separated into its components through filtering and centrifugating steps, thereby providing two rice components, comprising proteins with insoluble amylose and cellulose and dextrins.

Then, by an enzymatic hydrolisis (using proteasis with glucoamylasis and cellulasis, and/or acid hydrolysis and, separately, fibers, hydrolized proteins, glucose and soluble minerals), and by a partial enzymatic saccharification: dextrins, maltose and glucose, in proportions variable at will, are prepared.

Moreover, also starting from rice husking residues (husks or chaff,+gem/bran+germ), by pressing, centrifugating-extracting and separating, are prepared a fat portion (oil and lecithin) and proteins and carbohydrate residues (starch and cellulose).

Then, said two components are added to proteins with amylose and cellulose, obtained by the above process, and jointly subjected to the same enzymatic and/or acid hydrolysis process.

The thus obtained components (dextrins, glucose, maltose, hydrolyzed proteins, oil, lecithin, hydrolyzed fibers, minerals, vitamins) are finally collected, so as to change at will their rates, for recovering a balanced food product which can be further enriched with optional additives (vitamins, minerals, aminoacids and so on) and/or improved in its aesthetic aspect by technical and optional additives, thickening and coloring agents, natural aromas such as cocoa, mint, coconut, almond, coffee and the like.

The thus obtained product is then subjected to a filtering step and to a homogenizing step, and then, after a suitable thermal processing (pasteurization, UHT or sterilization) it is finally suitably packaged.

If the product is to be preserved in liquid form, then it is also be subjected to a concentrating step (before the end packaging), or to a combined concentrating and drying step; moreover it can also be packaged in powder form, to be successively recovered or reconstituted , at the use time, to a milk or cream form.

In particular, and as stated, the food product according to the invention can be made in several forms, in addition to the milk form, such, for example, rice pudding, rice yoghurt, rice ice cream, the so-called instantaneous mixtures, drinks or beverages, lecithin enriched milk, functional aminoacids, enriched milk and so on.

Lecithin enriched rice milk is a rice based functional food product, such as milk per se, with a minimum amount of 10% of dry fraction in lecithin, obtained by extraction from fat substances of rice bran and germ, preferably at a rate of 20-30% of dry fraction.

Rice whole lecithin contains in average 70% fats, in particular 25% saturated fats and 75% mono and polyunsaturated fats (40% mono-unsaturated and 35% polyunsaturated fats), 14%-15% phosphatydil coline, 2% coline, 1850 mg phosphorus, 220 mg magnesium, per each 100 g.

As known, the above are the most significative and interesting components, owing to their well known effect on the circulatory and brain system.

To the above it is to be added that rice lecithin is added for replacing soybean lecithin, a component which is broadly used for healthy purposes, but which because of a recent OGM pollution, is not appreciated and consumed as in past times.

However a combination of rice lecithin with its natural support, comprising rice milk, provides a particularly balanced supplementary food product, which is well tolerated and very appreciated because of its natural delicate sweetness.

Said functional aminoacid enriched rice milk is a rice milk based food product, as above disclosed, enriched with one or more aminoacids to fit feeding requirements of infants, sportsmen, sick persons and so on.

### EXAMPLE 1

The rice protein contains all of the eighteen aminoacids, on which depends a regular human metabolism.

Said rice protein, however, is relatively poor in lysine, cysteine, methyonine, thereby the assimilation of other aminoacids present in greater amounts is also reduced.

A balanced milk product, also with respect to the aminoacid profile, constituting the proteic portion, should require an addition of said aminoacids and possible other mineral and vitaminic aids, for aiding growth and development in a young age, and for sick and old persons.

### EXAMPLE 2

For meeting particular requirements, in athletically preparating of professional sportsmen and amateur players, their diet is conventionally supplemented by a lot of aiding products, such as hydrolyzed proteins and specific anabolic effect aminoacids, in alternative to drugs and hormones (which are dangerous and prohibited by law).

More specifically, the following aminoacids and optional integrating substances have been found as particularly useful:

acetil-L-carnitine, alanine, arginine, carnitine, isoleucine, leucinic valine, glutamine, monohydrated creatine;

calcium, chromium, iron, magnesium, potassium, zinc, selenium, C vitamine, fat acids, conjugated linoleic acid, phosphatydilserine.

A combination of a rice milk enriched in complex carbohydrates (dextrins) of a slow digestion type, and simple ready energy providing substances (maltose, glucose), with pre-digested hydrolyzed proteins, fat acids, mainly poly and monounsaturated, and optional supplementing substances having an anabolic and antioxidating effect, provides a liquid food product which can be easily used either before, during and after sports event.

It has been found that the invention fully achieves the intended aim and objects.

In fact, it provides a food product prepared starting from rice only, by an extracting and fractioning hydrolysis process, which food product contains all the rice components, i.e. carbohydrates, proteins, fats and some micro nourishing elements such as vitamins, minerals and fibers, with the possibility of changing their rates, depending on contingent needs, to meet all the requirements of the final users.

The thus made products can be used by all the population ranges, such as infants, sportsmen, old and sick persons and so on.

The food product according to the present invention is the first complete food in which all the components have the same origin, (they are divided from a single cereal, the rice, which, as above stated, is easily available, at a low cost and has an optimum tolerability).

Moreover, it should be pointed out that rice does not contains gluten, which could generate a lot of problems for a great number of persons.

From the above it should be apparent that the present invention is based on a novel idea to provide a rice food product, characterized by a general tolerability with well appreciated organoleptic aspects (that is good firmness, taste and nutritional characteristics, providing a milk like food product agreable for any persons).

The inventive food product contains all substances of rice, but in different rates, to meet specific requirements, starting from a whole rice grains which are processed by specifically designed technologies, to recover, after fractionating the parts thereof, a lighter food, of very good digestibility (since it is hydrolyzed), and much more rich (since the several components thereof can be enhanced at will).

This food product, moreover, can be easily used, and has a component ratio which can be changed at will and above a nutritionally correct and complete minimum.

With respect to the beverage field, it should be pointed out that even if conventionally available cereal based drinks and beverages can comprise while cereals, they, however, include mineral proteins and fibers only in trace amounts, since they are not hydrolyzed and are neither soluble nor suspensible, thereby the end result is a suspension/emulsion of dextrines, maltose and glucose, derived from hydrolysis of the rice starch only, in which are lacking fats, which are added in the form of seed oil (safflower, sunflower, or a mixture thereof).

According to the present invention, on the contrary, the inventive process starts from whole rice, and provides to fractionate the components thereof and then recover the fractionated product in selected rates, by industrial processes of a per se known type.

Thus, the invention provides a product which is as far possible similar to original rice, in which, moreover, are used all the rice substances . . .

Finally, the invention provides a polyvalent product, of natural and complete nature, by a process very similar to a natural process, and this mainly due to enzymatic transformations very similar to the processes the food products are subjected to during normal digestive human processes.

1. A rice-based food product, specifically designed for human nourishing, characterized in that said food product is made starting from whole rice, a fractionating extraction of said whole rice and a following recovering of said whole rice components, by varying their related amounts in a selected manner to provide a final food product having different and optimum nourishing characteristics.

2. A food product, according to claim 1, characterized in that said food product has a composition comprising at least 1% proteins, based on a rice milk per se, and 8% proteins based on the dry substances of said whole rice.

3. A food product, according to claim 2, characterized in that said food product has a composition comprising 1.5-2% proteins, based on said rice milk, 12.5% proteins based on said dry substances, thereby providing a composition similar to that of human milk.

4. A food product, according to claim 2, characterized in that said composition comprises up to 4% proteins, based on said rice milk, and up to 25% proteins based on said dry substances, thereby said composition is useful for nourishing sportsmen and sick persons.

5. A food product, according to claim 2, characterized in that said food product has a fat contents of at least 8% based on said dry substances, and of 1% based on said rice milk.

6. A food product, according to claim 2, characterized in that said food product has fat contents of 15% based on said dry substance.

7. A food product, according to claim 2, characterized in that said food product has a fat contents of 15% based on said dry substance, 1.5-2% based on said rice milk, at least 80% of said flat contents comprising monounsaturated and polyunsaturated fats.

8. A food product, according to claim 1, characterized in that said food product comprises a residual portion of carbohydrates, dextrins, maltose and glucose, in mutually variable rates.

9. A food product, according to claim 1, characterized in that said food product comprises soluble and/or micronized fibers, minerals and aromas.

10. A food product, according to claim 1, characterized in that said food product comprises rice milk, rice pudding, rice yoghurt, rice ice cream, instantaneous mixtures, drinks and beverages, lecithin enriched milk, and functional aminoacids enriched milk.

11. A method for making a rice-based food product according to claim 1, characterized in that said method comprises the steps of providing whole rice, processing said whole rice by a rice enzymatic transformation through alpha-amylasis and/or pollulanasis, filtering and centrifugating, to provide two composite derivate products comprising proteins with insoluble amylose and cellulose and dextrins.

12. A method according to claim 11, characterized in that said method comprises the steps of enzymatically hydrolyzing, by using proteasis with glucoamylasis and cellulasis, and/or acid hydrolysis, and then by separately including fibers, hydrolyzed proteins, glucose and soluble minerals, said method further providing the step of preparing, by a partial enzymatic saccharification, dextrins, maltose and glucose, in variable rates.

13. A method according to claim 11, characterized in that said method further comprises the steps of providing rice husking residues (rice husks+gems/bran+germ), and pressing and centrifuigally extracting and separating said residues, thereby providing a fat portion (oil and lecithin) and proteins and residue carbohydrates (starch and cellulose), adding said proteins and residue carbohydrates to amylose and cellulose and further processing by an enzymatic or acid hydrolysis.

14. A method according to claim 11, characterized in that said method further comprises the step of jointly collecting said dextrins, glucose, maltose, hydrolyzed proteins, oil, lecithin, hydrolyzed fibers, mineral and vitamins changing at will their rates and recovering a balanced food product to be further enriched in optional supplementary substances (vitamins, minerals, aminoacids, and so on) and/or enhanced in its aesthetic aspect by further technical additives, thickening, coloring agents, natural aromas such as cocoa, mint, coconut, almonds, coffee and the like.

15. A method according to claim 11, characterized in that said method further comprises a filtering step, an homogenizing step, a thermal processing step (pasteurizing, UHT or sterilization) and an end packaging step.

16. A method according to claim 15, characterized in that said product, in a liquid form, is also subjected to a concentrating step before said end packaging step, or to a concentrating and drying step and then being packaged in powder form to be recovered at an use time, as a rice milk or cream.
